(19) United States
(12) Patent Application Publication
(10) Pub. No.: US 2026/0141222 A1
(43) Pub. Date: May 21, 2026

(54) DATA CENTER SCALE PREDICTION-BASED POWER RESERVATION STEERING

(71) Applicant: NVIDIA Corporation, Santa Clara, CA (US)

(72) Inventors: Nir Arad, Snoqualmie, WA (US); Hadar Sivan, Kibbutz Dalia (IL); Gil Levy, Hod Hasharon (IL); Sridutt Bhalachandra, Concord, CA (US); Larry Dennison, Mendon, MA (US); Shie MANNOR, Haifa (IL)

(73) Assignee: NVIDIA Corporation, Santa Clara, CA (US)

(21) Appl. No.: 18/949,409

(22) Filed: Nov. 15, 2024

(51) Int. Cl. G06N 3/0475

(52) U.S. Cl. CPC G06N 3/0475

(57) ABSTRACT

In various examples, systems and methods are disclosed relating to data center scale prediction-based power reservation steering. One or more circuits can receive, from a plurality of components of a data center, power consumption data for a first time period. The one or more circuits can generate, using at least one prediction model and based at least on the power consumption data, a predicted power consumption of the plurality of components for a second time period following the first time period. The one or more circuits can determine a power policy for the plurality of components based at least on the predicted power consumption and a state of the data center and cause the plurality of components to limit power consumption for the second time period according to the power policy.

### BACKGROUND

Data centers are experiencing heightened energy consumption due to the escalating computational demands, contributing significantly to environmental concerns. Conventional power management strategies predominantly focus on regulating the power usage of central processing units (CPUs) within data centers. Generalized power management of modern data centers is challenging due to the demands of different workloads and the diversity of computing components.

### SUMMARY

Modern data center capacities are limited by power availability. However, once constructed, such data centers typically operate using a fraction of their available peak power capacity under normal conditions. Conventional approaches for addressing power management in data centers focus on managing the power consumption of active devices, including central processing units (CPUs) within the data center, leading to an incomplete and potentially inefficient power utilization strategy. Conventional approaches typically enforce high, fixed safety margins to ensure that data centers do not exceed maximum power allocation. Exceeding the maximum power consumption may result in significant datacenter downtime. Such traditional power management techniques also often rely heavily on application profiling data, which can be inadequate in environments that operate with a plurality of types of computational workloads. The use of specific application profiles can result in suboptimal power allocation for other types of workloads.

To address these limitations, the techniques described herein implement a centralized control loop that leverages predictive analytics to optimize power allocation across various components (e.g., any device of the data center for which power consumption is tracked/managed) within a data center. This system collects telemetry data from active components of data center clusters, encompassing graphics processing (GPU) devices, CPU devices, storage devices, and networking equipment, such as switches or routers, alongside power management systems. Based on the collected telemetry, one or more predictive models can be employed to forecast power consumption for each component over a subsequent time interval. The generated policy, which includes dynamically determined power caps for each component, can then be applied via hardware and software interfaces to enforce limits during the time interval. This process can be repeated to enforce dynamic policies over multiple time periods during data center operation, thereby enhancing overall efficiency and reducing operational costs.

At least one aspect relates to one or more processors. The one or more processors can include one or more circuits. The one or more circuits can receive, from a plurality of components of a data center, power consumption data for a first time period. The one or more circuits can generate, using at least one prediction model (e.g., machine-learning model, sliding window predictor, etc.) and based at least on the power consumption data, a predicted power consumption of the plurality of components for a second time period following the first time period. The one or more circuits can determine a power policy for the plurality of components based at least on the predicted power consumption and a state of the data center. The one or more circuits can cause the plurality of components to limit (e.g., restrict, control, constrain) power consumption for the second time period according to the power policy.

In some implementations, the at least one prediction model comprises a transformer model or a long short-term memory (LSTM) model. In some implementations, the at least one prediction model comprises a sliding window prediction function. In some implementations, the plurality of components comprises one or more of a graphics processing unit (GPU), a network interface controller (NIC), a network switch, a central processing unit (CPU), a storage device, or a cooling unit. In some implementations, the one or more circuits can determine the power policy further according to at least one job (e.g., current/enqueued jobs for the data center) executing on the plurality of components of the data center.

In some implementations, the one or more circuits can determine a predicted power consumption for the at least one job based at least on a prior instance of the at least one processing job. In some implementations, the one or more circuits can determine the power policy based at least on the predicted power consumption for the at least one processing job (e.g., determination of Hedge-based power policy on a per-job basis). In some implementations, the one or more circuits can determine the power policy further according to a power budget of the data center. In some implementations, the one or more circuits can select at least one hyperparameter for the at least one prediction model (e.g., Hedge-based optimization for prediction model) based at least on a prior predicted power consumption for a previous timestep. In some implementations, the one or more circuits can select the power policy from a plurality of power policies based at least on a prior predicted power consumption for a previous timestep.

At least one aspect relates to a system. The system can include one or more processors. The system can select at least one prediction model based at least on first power consumption data for a plurality of components of a data center during a first time period. The system can generate, using the at least one prediction model, a predicted power consumption of at least a subset of the plurality of components for a second time period following the first time period. The system can cause at least the subset of the plurality of components to limit power consumption for the second time period based at least on the predicted power consumption.

In some implementations, the system can select the at least one prediction model according to a Hedge function. In some implementations, the system can select the at least one prediction model by selecting one or more hyperparameters for the at least one prediction model based at least on the first power consumption data corresponding to the first time period. In some implementations, the system can select a power policy type based at least on the first power consumption data and a power budget of the plurality of components. In some implementations, the system can generate a power policy for the data center based at least on the first power consumption data and the power policy type.

In some implementations, the system can identify a second subset of the plurality of components assigned to a processing job of the data center. In some implementations, the system can select at least one second prediction model for the second subset of the plurality of components based at least on the first power consumption data. In some implementations, the system can generate a power policy for the second subset of the plurality of components based at least on a predicted power consumption of the second subset. In some implementations, the system can generate the power policy further based at least on an estimated time to determine maximum power draw during execution of the processing job.

At least one aspect is related to a method. The method can include obtaining power consumption data for a plurality of components of a data center during a first time period. The method can include generating, using at least one prediction model and based at least on the power consumption data, a predicted power consumption of the plurality of components for a second time period following the first time period. The method can include determining a power policy limiting power consumption of the plurality of components during a second time period, based at least on the predicted power consumption and a state of the data center.

In some implementations, the prediction model comprises a transformer model or a long short-term memory (LSTM) model. In some implementations, the prediction model comprises a sliding window prediction function.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a video language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing data center scale prediction-based power reservation steering are described in detail below with reference to the attached drawing figures, wherein:

FIG. 1 is a block diagram of an example system for implementing data center scale prediction-based power reservation steering, in accordance with some embodiments of the present disclosure;

FIG. 2 depicts an example diagram showing an example control loop used to implement prediction-based power reservation steering, in accordance with some embodiments of the present disclosure;

FIG. 3 is a flow diagram of an example of a method for implementing data center scale prediction-based power reservation steering;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

This disclosure relates to systems and methods for implementing data center-scale prediction-based power reservation steering. Data centers are increasingly becoming energy intensive due to the exponential growth in computational demands, leading to a significant environmental footprint. The available power infrastructure often limits data center designs.

Power-hungry computing accelerators like GPUs are becoming increasingly ubiquitous in modern data centers. Consequently, large-scale data centers have very large power variability between periods of low computational loads and high computational loads.

Overloading the available power budget in a data center is extremely costly. A power breaker flipping can cause hours, if not days, of downtime until all systems are brought back up and stabilized and until mitigations are put in place to prevent a recurring event. Consequently, the conventional approach for data center design ensures that the aggregate power of all data center components never exceeds the data center power budget, even if all of them simultaneously draw 100% of their nominal power, a design point known as no oversubscription.

During normal data center operation, it is never the case that 100% of the available power is used. In a typical data center, at any given time, some nodes are in repair due to hardware or software issues and some nodes are idle between running different workloads. In addition, nodes that are running workloads rarely utilize 100% of their power budget due to bottlenecks like memory capacity, memory bandwidth, network latency and bandwidth, or under-optimized algorithms. As a result, on average, most data centers utilize 40%-70% of their available power budget.

To address these deficiencies, the data center's design paradigm must shift from building under-subscribed data centers to building over-subscribed ones, and a novel power management system is required to manage such data centers efficiently. The techniques described herein implement a centralized control loop that leverages predictive analytics to optimize power allocation across components within an over-subscribed data center. To do so, the system collects telemetry data from active components of data center clusters, including but not limited to GPU devices, CPU devices, storage devices, networking equipment such as switches or routers, and power management systems. This telemetry includes real-time or near real-time metrics, such as power consumption metrics, for each component of the cluster.

Based on the collected telemetry, one or more predictive models are employed to forecast power consumption for each component over a subsequent time interval. The time interval may be, but is not limited to, 1 minute, 30 seconds, 15 seconds, 10 seconds, or 1 second. The prediction period may be the same or longer than the telemetry collection period. The predictive models can include any suitable type of machine-learning model and can predict an estimated power usage for each component over the subsequent time interval. In some implementations, the model may receive additional data as input, such as prior interval predictions for each component or power policy data for a prior time interval.

The predicted power consumption values for each component are then used to generate a policy for the corresponding time interval. The policy can include power limits for each component of the data center and may be determined based at least on the predicted power consumption, current data center state (which may include the power budget of the data center), and job scheduler information, among other inputs. The generated policy can include dynamically determined power caps for each data center component. The generated policy can then be applied via hardware and/or software interfaces to enforce limits imposed by the policy for each component during the time interval. This process can then be repeated to enforce dynamic policies over multiple time periods during data center operation.

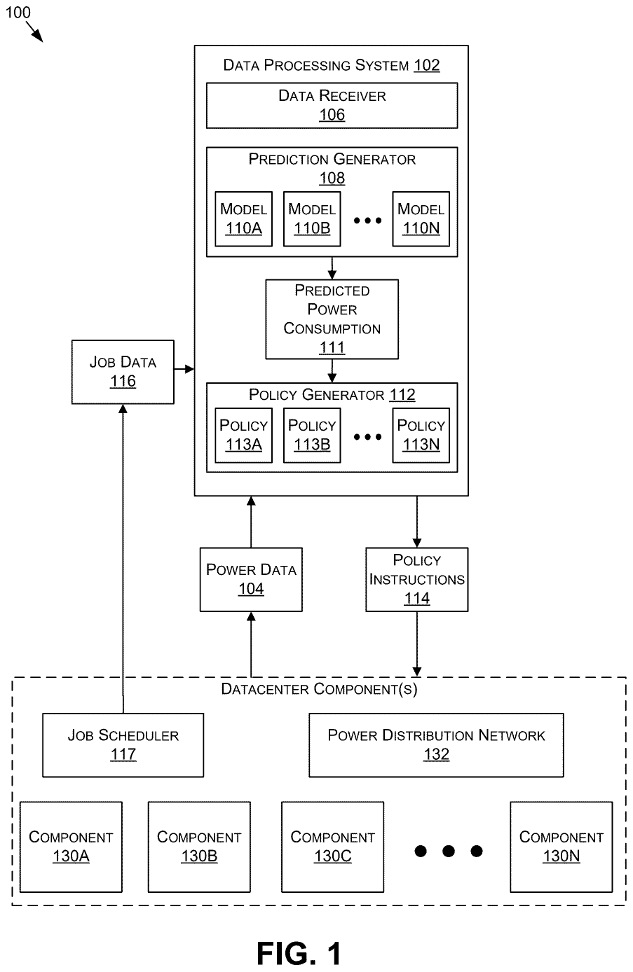

With reference to FIG. 1, FIG. 1 is an example computing environment including a system 100 for implementing data center scale prediction-based power reservation steering, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including a data processing system 102 and one or more data center components 130A-130N (sometimes referred to as “data center component(s) 130”). The data processing system 102 (and/or the components thereof) can receive power consumption data 104 and processing job data 116 (sometimes referred to as “job data 116”) from one or more data center components 130. The data processing system 102 (and/or the components thereof) can provide policy instructions 114 to the data center components 130 to implement real-time or near real-time power reservation steering. The data processing system 102 can execute a data receiver 106 to receive the power data 104 from the data center components 130 and execute a prediction generator 108 to generate a predicted power consumption 111 of the data center components 130 for a future time period (e.g., a time step). The prediction generator 108 can generate the predicted power consumption 111 using one or more prediction models 110A-110N (sometimes generally referred to as “prediction model(s) 110”). The data processing system 102 can execute a policy generator 112 to generate a power policy for the data center and transmit the policy instructions 114 to control the power consumption of the data center components 130.

The data center components 130 can include any type of device that is capable of reporting (or providing data to a device capable of reporting) real-time or near real-time power consumption in a data center. For example, data center components 130 can include any hardware that facilitates the processing, storage, and transmission of data within a data center. The data center components 130 can include servers, CPUs, GPUs, network interface controllers (NICs), and network switches, among other components/devices/systems. In some implementations, servers may include multiple data center components 130, each reporting power consumption data 104 independently. In some implementations, a data center component 130 may include one or more servers that report collective power consumption data 104, such that the data processing system 102 can control future power consumption of the one or more servers in the aggregate rather than granularly limiting/controlling the power consumption of the components thereof.

Central processing units (CPUs) can be included in nodes/servers/data center processing infrastructure. Each can include hardware or execute software that can report power consumption data 104 for corresponding time periods, as described in further detail herein. The data center components can include any suitable architecture, clock speed, and core count, among other attributes. In some implementations, data center components 130 including CPUs can be equipped with power management circuits or systems, which can dynamically control the frequency of the CPUs to control or otherwise limit the power consumption of the CPU in accordance with policy instructions 114, as described in further detail herein.

In some implementations, the data center components 130 can include one or more accelerated computing devices, such as Graphics Processing Units (GPUs) or artificial intelligence accelerator circuits/devices. GPUs within a data center can include any device with many parallel computation units and shared memory suitable for executing graphics processing tasks or machine learning such as tensor operations. The GPUs of the data center may be included in one or more processing nodes and may be connected via high-speed interconnects, such as PCIe, NVLINK, InfiniBand, or Ethernet, among others. In some implementations, GPUs can be included as part of a distributed computing cluster within the data center. In some implementations, the GPUs of the data center components 130 can report power consumption data 104 to the data processing system 102 at various time intervals. The GPUs can include hardware sensors or software interfaces that monitor and measure, or in some implementations, derive the power consumption of the GPU in real-time or near real-time over a configurable time period(s). In some implementations, the power consumption data 104 can be periodically sampled and aggregated over a specified time interval, such as every one millisecond, every second, every 10 seconds, or any other time interval (which may be configurable, as described herein). The power consumption data 104 can be transmitted or otherwise retrieved by the data processing system 102. The data processing system 102 can execute a data receiver 106 to retrieve this power consumption data 104 from the GPUs of the data processing system 102, which can then be used for predictive analytics and policy generation as described herein. In some implementations, the power consumption data 104 of the GPUs can be collected and/or transmitted by hardware and/or software of the computing devices/clusters hosting the GPUs.

In some implementations, the data center components 130 can include one or more network switches. Network switches can facilitate the communication and data transfer between various devices, components, and systems within the data center. For example, the switches can provide routing and switching capabilities for various networks implemented within the data center, and may support/implement various protocols and standards, including Ethernet, Fibre Channel, and InfiniBand, among others.

The network switches and/or NICs of the data center components 130 can report power consumption data 104 to the data processing system 102. The network switches can include power monitoring circuits or software that enable measurement and/or management of power usage across different ports and interfaces. The network switches can periodically collect the power consumption data 104 and can transmit it to the data processing system 102, to be received and processed by the data receiver 106 as described in further detail herein. The power consumption data 104 of the network switches can be provided to the data processing system 102 at predetermined/configurable time intervals, as described herein.

The power consumption data 104 provided by/retrieved from the data center components 130 can include any suitable metric to quantify the power consumption of each data center component 130 over a corresponding time interval. The power consumption data 104 may be a numerical value indicating an amount of power (e.g., in watts, milliwatts, kilowatts, etc.) used by a corresponding data center component 130 during the time interval. In one example, the power consumption data 104 may include an individual average power usage of each data center component 130 during the corresponding time interval.

In some implementations, certain data center components 130 may continuously report power usage data to the data receiver 106, and the data receiver 106 can calculate the cumulative/average power consumption of the corresponding data center components 130 over the predetermined time intervals. In some implementations, rather than receiving the power consumption data 104 from one or more data center components 130, the data receiver 106 can periodically poll/query the one or more data center components 130 to retrieve the power consumption data 104 for a corresponding time interval. The data receiver 106 can store the received/retrieved power consumption data 104 in a data structure for subsequent analysis by the prediction generator 108 and policy generator 112.

In some implementations, data center components 130 may be aggregated into “power domains”. Power domains may correlate with components of the data center power distribution network 132, including components such as a top-level power breaker, a per-hall breaker, a per-isle breaker, or other circuit breakers. In some implementations, power domains may be hierarchical, e.g., they may contain other power domains. The data processing system 102 may store/maintain and use power domain information for the data center components 130 and the power distribution network 132 to determine the power budget of each domain. In addition, some power domains may support telemetry collection, which may be read by data receiver 106 and used by policy generator 112 to track power management compliance and to monitor the necessary safety margins to avoid any circuit breaker from tripping.

The data receiver 106 may receive job data 116 from one or more job schedulers 117. The job scheduler 117 can include software, hardware, or combinations thereof that operate within the data center to manage and allocate processing jobs across various data center components 130. The job scheduler 117 can receive and process job requests, which can include detailed specifications and requirements for executing different processing tasks. For example, the job scheduler 117 can determine the appropriate modes (e.g., data center components 130) that are to be assigned a given processing job based on the computational load and resource requirements indicated in the job data 116.

The job scheduler 117 can generate job data 116 that includes any information related to one or more processing jobs that are scheduled or executed by the data center components 130. The job data 116 can include information relating to processing requirements, characteristics, or identifiers of one or more processing jobs. For example, the job data 116 can indicate the expected processing time required for a processing job, the number of data center components 130 to execute the processing job, a status of the processing job, and identifiers of the data center components 130 that are assigned to the job, among other information. The job data 116 can specify the allocation of resources across different types of data center components 130, such as CPUs, GPUs, NICs, and network switches.

In some implementations, the job data 116 can also include information about the type of instructions implemented by the processing job, the type of data to be processed using the processing job, or other information relating to one or more processing jobs. For example, the job data 116 can specify whether the processing job involves CPU-intensive tasks, GPU-intensive tasks, or a combination of both. In some implementations, the job data 116 can indicate the expected computational load and resource requirements of the processing job. In some implementations, the job data 116 can include metadata associated with the processing job, such as the priority level or the type of workload (e.g., machine learning, data analytics, web services, etc.), among other metadata.

In some implementations, the job data 116 may include indications of whether power capping is to be applied to data center components 130 that execute a particular processing job. Certain processing jobs may be flagged (e.g., in the job data 116) as being restricted from power capping or limitations, such that the processing job can be executed using the maximum processing capabilities of the components 130 to which it is assigned. In such implementations, the job data 116 may include a flag indicating that the power of the components 130 that are to execute the processing job is not to be limited. In some implementations, the job data 116 may indicate a minimum power allocation that is to be guaranteed for each of the components 130 assigned to the job. Processing job data 116, including any metadata associated therewith, may be provided by one or more job schedulers 117 of the data center.

The prediction generator 108 can access the power consumption data 104 and generate predicted power consumption data 111 for the next time interval. The prediction generator 108 can generate the predicted power consumption 111 for some or all data center components 130 for a subsequent time interval using one or more prediction models 110. Each prediction model 110 can be any type of model that can predict (or be used/executed/applied to predict) power consumption of one or more data center components 130 for a subsequent time given prior power consumption data 104. In one example, one or more prediction models 110 can be machine-learning models, including but not limited to recurrent neural networks (RNNs) such as long short-term memory (LSTM) models, transformer-based models, or any other type of machine-learning model.

In one example, one or more prediction models 110 can include LSTM machine-learning models. The LSTM model can be trained/updated to forecast power consumption based on historical and real-time telemetry data, for example, using supervised learning techniques. The LSTM model may include various hidden state sizes ranging, for example, from 5 states to 60 states, and can include any number of parameters, including up to 50,000 parameters. An implementation where the prediction model 110 includes a transformer model can similarly include any number of transformer layers and may include up to 150,000 parameters in one example. The transformer model may be any suitable transformer-based machine-learning model that can be trained/updated to receive multivariate time-series data and generate regression/classification outputs.

In some implementations in which the prediction model 110 includes a transformer model and/or an LSTM/RNN model, the prediction model 110 may receive/store multiple time-steps (e.g., time intervals) as input and generate predicted power consumption data 111 for each data center component 130 (or a subset of data center components 130) for a subsequent time interval. Any suitable number of prior time intervals of power consumption data 104 may be used as input to the prediction model 110, including power consumption data 104 ranging from 5 minutes to about 60 minutes, in some implementations. Time intervals in various implementations may include time intervals of 15 milliseconds, 1 second, 5 seconds, 15 seconds, 30 seconds, or 1 minute, among others.

In some implementations, the prediction model 110 may include one or more sliding window predictors. The sliding window predictors can be used to calculate statistics such as the mean, standard deviation, and maximum power consumption values of the data center components 130 (or a subset thereof) over a sliding window of recent power consumption data 104 values. The sliding window predictor can combine the statistical calculations to generate a predicted power consumption data 111 for the data center components 130 (or a subset thereof). In one example, the sliding window predictor can calculate the mean and the standard deviation of the power consumption data from any number of prior intervals of power consumption data 104 for the data center components 130. The sliding window predictor can then sum the mean and twice the standard deviation to produce a prediction for the next time interval. In another example, the sliding window predictor can generate a predicted power consumption using a sum of the maximum plus the standard deviation of any number of prior intervals of power consumption data 104 for the data center components 130.

In some implementations, the prediction generator 108 can operate as a Hedge instance that executes multiple prediction models 110 to determine the optimal predicted power consumption 111 of the data center components 130. For example, one or more prediction generators 108 can execute a Hedge algorithm to track the loss of multiple prediction models 110 to generate optimal power consumption values 111. In such implementations, each prediction model 110 implemented using the prediction generator 108 may include a respective set of hyperparameters and/or model type (e.g., LSTM, sliding window, etc.). The prediction generator 108 can operate by evaluating multiple prediction models 110 in parallel and selecting the output of the best prediction model 110 based on the evaluation.

To implement the Hedge function, the prediction generator 108 can implement a loss function which helps the prediction generator 108 to evaluate the performance of each prediction model 110 (e.g., each set of hyperparameters, each different type of prediction model 110, etc.). In one example, the loss function can be a root mean square error (RMSE) of each prediction model 110. For each prediction model 110, the loss can be calculated for the current time interval and updated at the next time interval as subsequent power consumption data 104 is received. Once the loss for each prediction model 110 is calculated, the Hedge function can update and select the output of the prediction model 110 having the lowest loss value, which is provided as the predicted power consumption values 111.

Although only a single prediction generator 108 (e.g., a Hedge instance) is shown here, in some implementations, there could be multiple prediction generators 108 implemented as multiple Hedge instances, in which the predicted power consumption values 111 for multiple subsets of the data center components 130 can be generated separately using a corresponding Hedge instance. In some implementations, a single global Hedge instance can be used, such that the predicted power consumption 111 for all data center components 130 is generated using the same prediction generator 108 (and one or more corresponding prediction models 110). In some implementations, multiple respective Hedge instances may be implemented for multiple data center components 130 in a cluster or set of clusters of data center components 130 or may be provided for different processing jobs indicated in the job data 116, as described in further detail herein.

In one example, multiple prediction generators 108 are initialized to implement Hedge instances on a per-job basis, rather than on a global prediction basis. In such implementations, a prediction generator 108 can be initialized upon a new processing job being detected in the job data 116. The initialized prediction generator 108 can implement a Hedge function according to the techniques described herein by iteratively calculating a loss for each of its prediction models 110 based on power consumption data 104 of components 130 assigned to the processing job. The output of the prediction model 110 having the lowest loss for predicting the power consumption data 104 of the components 130 can be selected to generate the predicted power consumption values 111 for those components. Once the processing job has been completed, the Hedge instance for the job can be released/deallocated. In some implementations, the data processing system 102 can store the loss values of the Hedge instance for use with subsequent processing jobs having similar attributes (e.g., similar operations, data, etc.) that are to be executed by the data center components 130. Upon detecting such a processing job in the job data 116, a new prediction generator 108 can be initialized to implement a Hedge instance that uses the loss values (the collection of prediction models 110) from similar prior job(s) to select the output of a prediction model 110 to generate the predicted power consumption values 111.

The predicted power consumption 111 can be provided to the policy generator 112 to determine policy instructions 114 from one or more power policies 113A-113N (sometimes generally referred to herein as a “power policy 113” or “power policies 113”) to control power limits for one or more data center components 130. The policy instructions 114 can be generated to increase additional compute power within a given data center power budget relative to conventional approaches. The policy generator 112 can generate policy instructions 114, which can include instructions to control power limits/caps for different data center components 130. A power policy 113 can be determined, generated, and/or modified for each time interval for which predicted power consumption values 111 are calculated. The power policy 113 can be determined as a function of the available power capacity of each component 130 of the data center and the predicted power consumption 111 of one or more components 130 of the data center.

In some implementations, the power policy 113 can be determined further based on a state of the data center, which may include but is not limited to information such as current processing load, power budget of the data center, a minimum power consumption of each component 130 of the data center, information of one or more current or scheduled processing jobs indicated in the jobs data 116, and/or information indicating which data center components 130 are active/online or inactive/offline for processing tasks, among other information. The state of the data center may be maintained, determined, or otherwise identified based on communications from one or more data center components 130 or other information sources (e.g., status databases, etc.) associated with the data center.

A power policy 113 can be generated and/or determined using a variety of techniques. In one example, a policy generator 112 can determine/implement a power policy 113 using the predicted power consumption 111 of data center components 130, the minimum and maximum power limits of each data center component 130 (e.g., hardware constraints, etc.), and a maximum allowable power consumption of all devices in the data center (e.g., a maximum power budget). To determine/calculate output power limits according to the power policy 113, the policy generator 112 can allocate data structures to represent the power consumption of each active data center component 130 and add the minimum power consumption to the data structures (which is the default minimum amount while active). At this stage, the remaining power budget for the data center is the maximum power budget minus the minimum power consumption of each active component 130.

The policy generator 112 can then calculate the sum of additional power required to satisfy all power predictions for each component 130, by summing the predicted power values 111 minus corresponding minimum power values for each component 130. If the remaining power budget is less than or equal to the additional power to satisfy all power predictions, each component 130 can be allocated (e.g., data structure updated by summing) an equally pro-rated power budget, so the sum of allocations is equal to the available power budget. At each allocation, the policy generator 112 can ensure that each component is allocated power within its minimum and maximum power thresholds, adjusting if needed. As these adjustments may affect the power balance of the data center, the policy generator 112 can iteratively check and adjust limits of the data center components 130 to enforce the power budget of the data center while conforming to the minimum and maximum thresholds of each component 130.

As described herein, in some implementations, the job data 116 may indicate that one or more power components 130 are to be uncapped, or otherwise operate at their maximum power consumption values. In such implementations, the policy generator 112 can determine/calculate a policy for the components 130 that allocates maximum power consumption to those components 130, while limiting power consumption of other components 130 according to the power budget of the data center. In some implementations, the policy generator 112 can calculate multiple different types of policies for multiple subsets of components 130, including for subset(s) of components 130 assigned to one or more processing jobs or having different power allocation priorities within the data center.

In some implementations, the policy generator 112 can implement a Hedge algorithm to select between multiple different power policies 113 to enforce power caps for one or more data center components 130. To implement the Hedge algorithm, the policy generator 112 can implement multiple policies 113 in parallel. The policies 113 can be models (sometimes referred to as “policy experts 113” or “policy models 113”) that implement rules for setting power limits/caps for data center components 130 based on specific inputs (e.g. prediction power consumption data 111, other data described herein, etc.), to satisfy power constraints such as global or domain power budgets while ensuring the power limit/cap for each data center component 130 falls within corresponding hardware limits. Policy models 113 may implement different hyperparameters, including but not limited to a job initial window size (e.g., where no caps are enforced on a job's devices until its behavior is learned), and/or may differ in how they allocate the remaining power budget (after predictions). For example, one policy 113 can split the power budget equally among data center components 130, while another policy can apply proportional fairness, among other approaches.

In some implementations, the policy generator 112 can implement a single global policy Hedge instance per power domain, due to global power budget constraints (e.g., the limits imposed on different components 130 are interdependent). In some implementations, an entire cluster of the data center may operate on a single power domain, meaning only one single global policy Hedge instance is implemented. In some implementations, the data center may include multiple power domains, and the data processing system 102 can execute a respective policy generator 112 to implement a respective Hedge instance for each power domain in the data center.

The Hedge instance implemented by the policy generator 112 can be a function of the power budget of all data center components 130 whose power is affected by the policy instructions 114 generated by the Hedge instance. In one example, the loss can be a measure of the total number (or in some implementations, percentage) of data center components 130 that encounter insufficient (e.g., underestimated) power budget relative to the power budget allocated to those components 130 for the previous time interval. The loss can be determined from the power data 104 received from the components 130. Other losses may also be implemented by the policy generator 112, including but not limited to root mean squared error-type losses or any other type of loss function that is a function of the underestimations of power budgets for each data center component 130 at the prior time interval.

In some implementations, the policy generator 112 can implement a positive backoff function, for example, in scenarios where power allocated to one or more data center components 130 is determined to be insufficient. The positive backoff function can be implemented such that the data center components 130 can receive sufficient power to operate efficiently without over-provisioning. In one example, the positive backoff function can automatically increase the predicted power consumption for one or more components 130 exponentially based on the number of consecutive time intervals where the power consumption data 104 for those data center components 130 is equal to, or about equal to, the power allocation, indicating that the allocated power was insufficient. This can compensate for the power consumption of those data center components 130 being limited by the power allocated to those data center components 130 due to power capping. The policy generator 112 uses the positive backoff function to increase the predicted power consumption 111 for the next time interval to ensure adequate power allocation to the data center components 130.

In some implementations, the policy generator 112 can use the job data 116 to determine/calculate one or more different types of power policies for one or more data center components 130. For example, the job data 116 can indicate that a particular processing job is to be executed in a subsequent time interval. Upon identifying a job that is to be executed, the policy generator 112 can allocate a data structure storing a value for the maximum power observed as being consumed during the processing job (or similar job type). The maximum power value can be initialized to an initial value (e.g., zero, a very large number, etc.), and can be updated during an initial time period. The initial time period can be a period of time during which no job-specific policy changes are made for the corresponding processing job, and an estimated maximum power consumption (e.g., for a given time interval of power consumption data 104) for the job can be determined.

The time to observe the estimated maximum power consumption for a processing job can vary and may be selected according to the type of processing job or any other metadata/configuration information for the processing job. In some implementations, the amount of time may be a predetermined or estimated amount of time. In some implementations, the policy generator 112 can estimate the maximum amount of power for the processing job based on the characteristics of the processing job. Once the maximum power consumption for the processing job has been determined, the policy generator 112 can determine/calculate a policy that avoids allocating power to the components 130 executing the processing job that exceeds the estimated maximum power for the processing job. This type of power policy can be implemented as it is unlikely that in the subsequent time steps a higher power consumption will occur during execution of the job by those data center components 130.

The output of the power policy 113 determined/calculated by the policy generator 112 can include a set of power cap values (e.g., the allocated power amounts) for one or more data center components 130. These values can be converted into a set of policy instructions 114, which can be instructions, commands, or operations that cause each active data center component 130 to conform to its respective power cap value during the subsequent time interval. The policy instructions 114 may be generated into formats compatible with each respective component 130, each of which may include different architectures, power profiles, operating points, and control/operation configurations. The policy instructions 114 may be transmitted such that the instructions can be implemented by the data center components 130 for the subsequent time period with minimal latency.

The data processing system 102 can provide the policy instructions 114 to the data center components 130 to control the power consumption caps of different devices in a predetermined order. For example, the data processing system 102 can provide first policy instructions 114 to components 130 of the data center whose power caps are being reduced, in order to reduce the total power consumption of the data center prior to providing second policy instructions 114 to increase the power caps of other components 130 of the data center. Doing so prevents circumstances where the power caps of previously capped components 130 are removed or greatly increased, potentially causing a sudden increase in aggregate power consumption of the data center before policy instructions 114 can be provided to other components 130 to reduce their power consumption caps/limits.

Once the policy instructions 114 have been provided, the power consumption caps of the components 130 can be updated to enforce the power policy generated by the power policy for the following time interval. This may include updating configuration information of each component 130 to limit the amount of power that the corresponding component 130 can consume. In some implementations, the power consumption caps enforced using the policy instructions 114 can remain in effect until the corresponding component 130 is reset, reinitialized, or receives other policy instructions 114 to modify the current power consumption configuration of the component 130.

The data processing system 102 can then receive updated power consumption data 104 for the subsequent time interval, and can repeat the techniques described herein to calculate a power policy for each time interval. The time interval at which power policies and/or policy instructions 114 are generated can be a hyperparameter stored in the configuration settings of the data processing system 102. Configuration settings can be updated via operator input to the data processing system 102 and/or in response to messages/commands from external computing systems or computing system(s) within the data center. The data processing system 102 can be internal to the data center or, in some implementations, external to the data center.

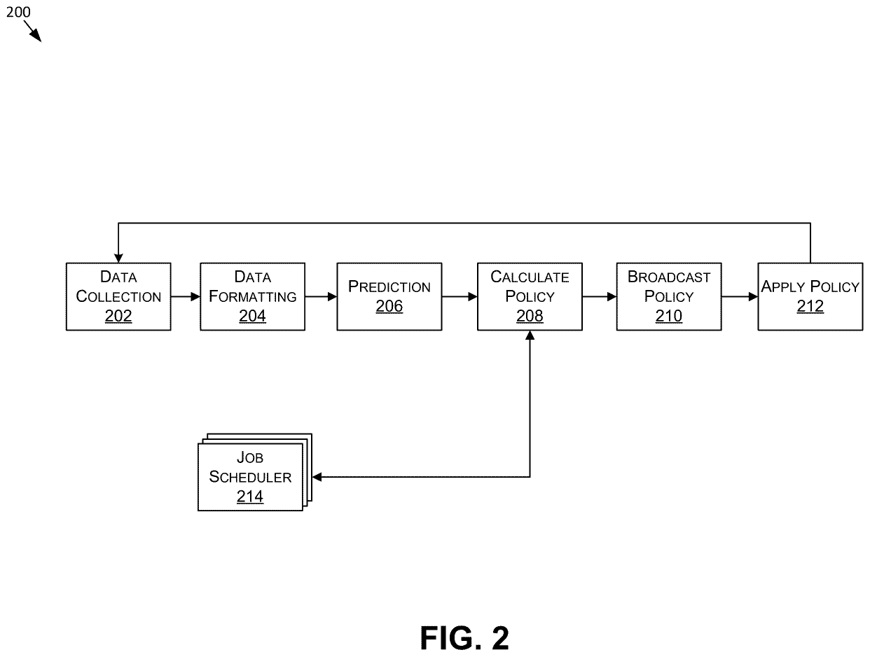

Referring to FIG. 2, an example diagram 200 depicts an example control loop used to implement prediction-based power reservation steering, in accordance with some embodiments of the present disclosure. As shown, the control loop begins with a data collection step 202, in which each component of the data center (e.g., data center components 130) that is subject to the power capping/configuration techniques described herein collects/determines its power consumption instantaneously or as an average over a predetermined time period (e.g., a time interval). Average power consumption can be calculated by measuring energy use over the time period and dividing the energy use by the length of the time period. The data collection step 202 can be performed by each component in the data center and may include accessing current/voltage/power sensors that report power consumption at regular sampling intervals.

The control loop continues at the data formatting step 204, in which a power management system (e.g., the data processing system 102) receives, stores, and, in some implementations, formats the power consumption data (e.g., the power consumption data 104) generated at step 202 from each component. The data formatting step 204 may also involve cleaning/addressing missing telemetry data. The power management system can then execute a prediction model (or multiple prediction models, e.g., implementing a Hedge function) at the prediction step 204 to generate predicted power consumption values (e.g., predicted power consumption values 111) for each component.

The power management system can calculate (determine, obtain, generate, etc.) a policy at step 208 using the predicted power consumption values. In some implementations, and as shown here, a job scheduler 214 (e.g., a provider of job data 116) can provide job information that is used by the power management system to calculate/determine/etc. one or more power policies as described herein. Once determined, the power management system can broadcast the power policy to the components of the data center at step 210, which may involve generating instructions (e.g., policy instructions 114) for each applicable component to implement a respective power consumption cap indicated in the policy.

Upon receiving the instructions, the components of the data center can apply the policy at step 212 for a subsequent time interval, by establishing power consumption caps according to the policy broadcast at step 210. In some implementations, the policy for the subsequent time interval can be applied in two phases. During the first phase, all components whose power limits are to be reduced are reduced according to the policy. Once the power limits have been reduced, the second phase increases the power limits for all components according to the policy whose power is to be increased for the subsequent time period. The power consumed during this time period while enforcing the generated policy can then be collected to calculate/determine a policy for a subsequent time period. This process can be repeated to continuously monitor and/or manage power consumption of one or more components in the data center.

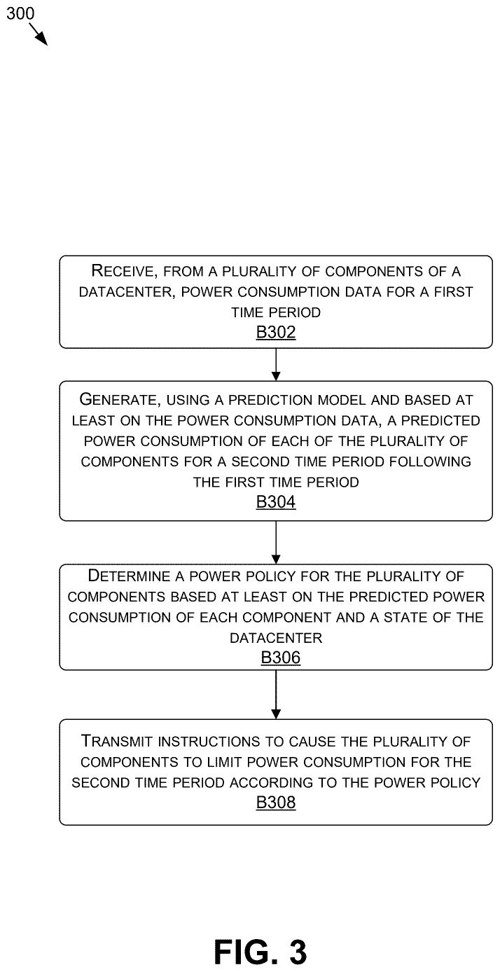

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by any number of circuits, logical devices, an application, a service or hosted service (standalone or in combination with another hosted service), or a plug-in to another product, to name a few. In addition, method 300 is described, by way of example, with respect to the system 100 of FIG. 1. However, this method may additionally or alternatively be executed by any one system, or any combination of systems, including, but not limited to, those described herein.

FIG. 3 is a flow diagram showing a method 300 for implementing data center scale prediction-based power reservation steering, in accordance with some embodiments of the present disclosure. The method 300, at block B302, includes receiving, from a plurality of components of a data center (e.g., data center components 130), power consumption data (e.g., power consumption data 130) for a first time period. The power consumption data can be collected and/or derived at each of the data center components over the time period, and transmitted to a power management system (e.g., the data processing system 102, the system performing the method 300, etc.). The power consumption values may include an average power consumption over the time period, and may be provided in milliwatts, watts, or kilowatts, among other possible values. In some implementations, the power consumption values can be determined based on sensors or other circuits of the data center components responsible for measuring the power consumption of the component in real-time or near real-time.

The method 300, at block B304, includes generating, using a prediction model and based at least on the power consumption data, a predicted power consumption (e.g., the predicted power consumption 111) of the components of the data center for a second time period following the first time period. The prediction model may include an RNN model, an LSTM model, a transformer model, or a sliding window prediction model. In some implementations, multiple prediction models can be executed according to a Hedge function/Hedge instance, as described herein. The Hedge function can be used to select the optimal prediction model to use in generating the predicted power consumption of the data center components. In some implementations, Hedge instances can be created for one or more processing jobs (e.g., indicated in the job data 116) to be executed by the components of the data center.

The method 300, at block B306, includes determining a power policy for the components of the data center based at least on the predicted power consumption and a state of the data center. Calculating/determining the power policy can include performing any of the techniques described herein in connection with the policy generator 112 of FIG. 1. For example, the power policy can be generated as a function of the minimum power consumption of each component, the predicted power consumption of each component, and a power budget of the data center. In some implementations, multiple policies can be calculated/determined according to one or more Hedge instances. In one example, a global Hedge instance can be implemented for the components of the data center. The power policy can specify power caps for each component of the data center to which the power policy corresponds.

The method 300, at block B308, includes transmitting instructions (e.g., policy instructions 114) to cause the components of the data center to limit power consumption according to the power policy. The policy instructions may include instructions to modify one or more configurations of the components to cause the component to limit its respective power consumption over the second time period. Transmitting the instructions may include transmitting first instructions to reduce power caps prior to transmitting second instructions to increase power caps, to avoid potentially exceeding the power capacity of the data center. Once the instructions are provided, each component can execute/implement the instructions to reduce, increase, or maintain their respective power consumption limits. The method 300 may then return to step 302 to receive power consumption for the second time period.

The systems and methods described herein may be used for a variety of purposes, by way of example and without limitation, for circuit layout definition, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models - such as one or more large language models (LLMs), systems for performing light transport simulation, systems for performing collaborative content creation for 3D assets, systems implemented at least partially using cloud computing resources, and/or other types of systems.

### Example Computing Device

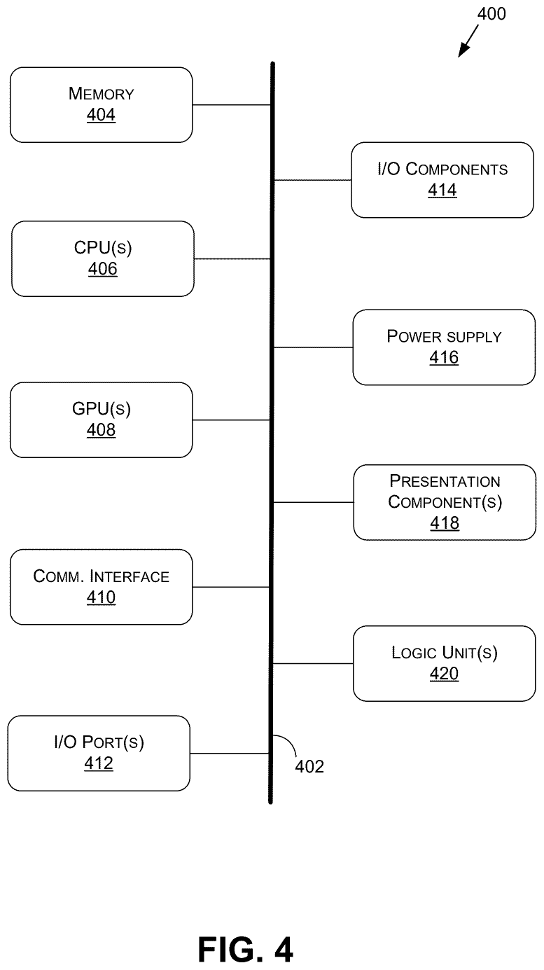

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

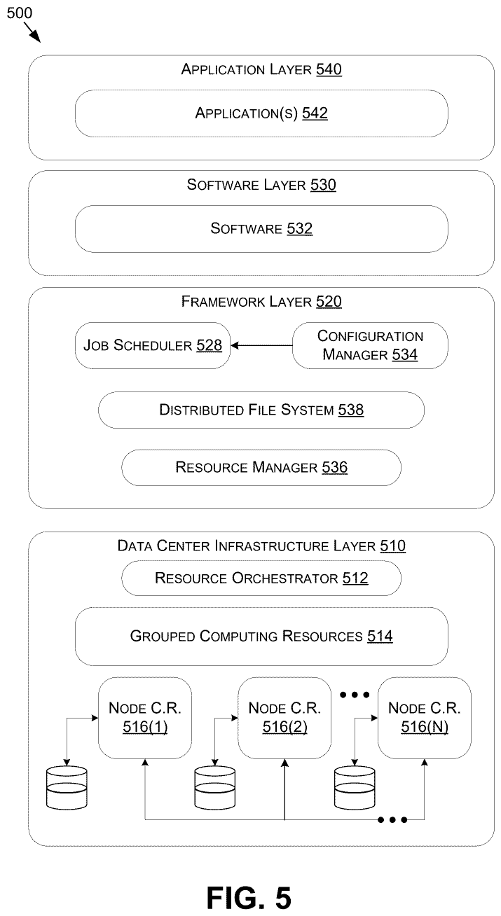

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.Rs”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules (e.g., cooling units), etc. In some embodiments, one or more node C.R. s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments. In some implementations, the node C.R.s 516(1)-516(N) can include one or more compute nodes, storage nodes, and/or management nodes of the data center. One or more of the node C.R.s 516(1)-516(N) may operate as a power reservation steering controller entity by executing the operations described in connection with the data processing system 102 of FIG. 1. In some implementations, one or more management nodes may be designated to execute data center management software (e.g., as head nodes). The job scheduler 528 may execute on one or more of the head nodes of the data center.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train/update one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained/updated or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train/update or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive, from a plurality of components of a data center, power consumption data for a first time period;
generate, using at least one prediction model and based at least on the power consumption data, a predicted power consumption of the plurality of components for a second time period following the first time period;
determine a power policy for the plurality of components based at least on the predicted power consumption and a state of the data center; and
cause the plurality of components to limit power consumption for the second time period according to the power policy.

2. The one or more processors of claim 1, wherein the at least one prediction model comprises a transformer model or a long short-term memory (LSTM) model.

3. The one or more processors of claim 1, wherein the at least one prediction model comprises a sliding window prediction function.

4. The one or more processors of claim 1, wherein the plurality of components comprises one or more of a graphics processing unit (GPU), a network interface controller (NIC), a network switch, a central processing unit (CPU), a storage device, or a cooling unit.

5. The one or more processors of claim 1, wherein the one or more circuits are to:
determine the power policy further according to at least one job executing on the plurality of components of the data center.

6. The one or more processors of claim 5, wherein the one or more circuits are to:
determine a predicted power consumption for the at least one job based at least on a prior instance of the at least one job; and
determine the power policy based at least on the predicted power consumption for the at least one job.

7. The one or more processors of claim 1, wherein the one or more circuits are to:
determine the power policy further according to a power budget of the data center.

8. The one or more processors of claim 1, wherein the one or more circuits are to:
select at least one hyperparameter for the at least one prediction model based at least on a prior predicted power consumption for a previous timestep.

9. The one or more processors of claim 1, wherein the one or more circuits are to:
select the power policy from a plurality of power policies based on based at least on a prior predicted power consumption for a previous timestep.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a small language model (SLM);
a system for performing generative AI operations using a video language model (VLM);
a system for performing generative AI operations using a multimodal language model;
a system for generating synthetic data;
a system incorporating one or more virtual machines (VMs);
a system implemented at least partially in a data center; or
a system implemented at least partially using cloud computing resources.

11. A system, comprising:
one or more processors to:
select at least one prediction model based at least on first power consumption data for a plurality of components of a data center during a first time period;
generate, using the at least one prediction model, a predicted power consumption of at least a subset of the plurality of components for a second time period following the first time period; and
cause at least the subset of the plurality of components to limit power consumption for the second time period based at least on the predicted power consumption.

12. The system of claim 11, wherein the one or more processors are to:
select the at least one prediction model according to a Hedge function.

13. The system of claim 11, wherein the one or more processors are to:
select the at least one prediction model by selecting one or more hyperparameters for the at least one prediction model based at least on the first power consumption data corresponding to the first time period.

14. The system of claim 11, wherein the one or more processors are to:
select a power policy type based at least on the first power consumption data and a power budget of the plurality of components; and
generate a power policy for the data center based at least on the first power consumption data and the power policy type.

15. The system of claim 11, wherein the one or more processors are to:
identify a second subset of the plurality of components assigned to a processing job of the data center;
select at least one second prediction model for the second subset of the plurality of components based at least on the first power consumption data; and
generate a power policy for the second subset of the plurality of components based at least on a predicted power consumption of the second subset.

16. The system of claim 15, wherein the one or more processors are to:
generate the power policy further based at least on an estimated time to determine maximum power draw during execution of the processing job.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a small language model (SLM);
a system for performing generative AI operations using a video language model (VLM);
a system for performing generative AI operations using a multimodal language model;
a system for generating synthetic data;
a system incorporating one or more virtual machines (VMs);
a system implemented at least partially in a data center; or
a system implemented at least partially using cloud computing resources.

18. A method, comprising:
obtaining power consumption data for a plurality of components of a data center during a first time period;
generating, using at least one prediction model and based at least on the power consumption data, a predicted power consumption of the plurality of components for a second time period following the first time period; and
determining a power policy limiting power consumption of the plurality of components during a second time period, based at least on the predicted power consumption and a state of the data center.

19. The method of claim 18, wherein the at least one prediction model comprises a transformer model or a long short-term memory (LSTM) model.

20. The method of claim 18, wherein the at least one prediction model comprises a sliding window prediction function.
